(19) United States
(12) Patent Application Publication
(10) Pub. No.: US 2012/0285992 A1
(43) Pub. Date: Nov. 15, 2012

(54) FOAM PUMP

(75) Inventors: Nick E. Ciavarella, Seven Hills, OH (US); John J. McNulty, Broadview Heights, OH (US); James M. Yates, Akron, OH (US); Robert L. Quinlan, Stow, OH (US)

(73) Assignee: GOJO INDUSTRIES, INC., Akron, OH (US)

(21) Appl. No.: 13/465,352

(22) Filed: May 7, 2012

Related U.S. Application Data
(60) Provisional application No. 61/484,460, filed on May 10, 2011.

(51) Int. Cl. B67D 7/70; B67D 7/72

(52) U.S. Cl. 222/138; 222/190

(57) ABSTRACT

Dispensing systems and refill units are disclosed herein. One exemplary refill unit includes a liquid reservoir and a rotary liquid pump having a liquid inlet in fluid communication with the liquid reservoir. The rotary liquid pump includes a housing, wherein at least a portion of the housing is resilient and a rotor that has one or more apexes. During operation, the one or more apexes contact the resilient portion of the housing and deflect the resilient portion of the housing resulting in the movement of a liquid. A mixing chamber having a liquid inlet and an air inlet is also provided. The liquid pump outlet is in fluid communication with the mixing chamber liquid inlet and the air inlet if in fluid communication with an air pump. An outlet nozzle is in fluid communication with the mixing chamber outlet for dispensing foam formed by mixing the liquid and air together.

### PRIORITY STATEMENT

This application claims the benefits of and priority to U.S. Provisional Patent Application No. 61/484460 filed on May 10, 2011, which is incorporated herein by reference in its entirety.

### TECHNICAL FIELD

The present invention generally relates to foaming pumps. More particularly, the present invention relates to a rotary pump for pumping liquid, such as soap or sanitizer combined with various air pumps/compressors for combining the pumped liquid with pressurized air to form a foam.

### BACKGROUND OF THE INVENTION

Liquid dispensers, such as liquid soap and sanitizer dispensers, provide a user with a predetermined amount of liquid upon the actuation of the dispenser. It is known to dispense liquids, such as soaps, sanitizers, cleansers and disinfectants from a dispenser housing that uses a removable and replaceable cartridge containing the liquid. The pump mechanisms employed with such dispensers are typically liquid pumps that emit a predetermined quantity of the liquid upon movement of an actuator. In some instances, it is desirable to dispense the liquids in the form of foam by, for example, interjecting air into the liquid creating a foamy mixture of liquid and air bubbles.

### SUMMARY

Foam dispensing systems are disclosed herein. One system includes a housing and an actuator for causing the dispenser to dispense foam. A holder for receiving a liquid reservoir, a liquid reservoir and rotary liquid pump are also disclosed herein. The rotary liquid pump is in fluid communication with the liquid reservoir and includes a pump housing wherein a least a portion of the pump housing has a substantially circular cross-section. The housing includes a liquid inlet and a liquid outlet. A sealing member is located between the liquid inlet and the liquid outlet. The liquid pump includes a liquid pump rotor that has one or more recesses located therein. During operation, the sealing member is configured to seal against the one or more recesses when the recess is aligned with the sealing member. The liquid inlet is in fluid communication with the liquid reservoir and the liquid outlet in fluid communication with a mixing chamber. In addition, an air pump having air inlet and an air outlet is also included. The air outlet is in fluid communication with the mixing chamber and the mixing chamber is in fluid communication with an outlet nozzle.

An exemplary refill unit for a dispensing system includes a liquid reservoir connected to a rotary liquid pump. The liquid rotary pump includes a housing, wherein at least a portion of the housing is resilient and extends along a plane; and a rotor, wherein at least a portion of the rotor includes a planar portion. A liquid inlet is in fluid communication with the liquid reservoir and a liquid outlet is in fluid communication with a mixing chamber. The mixing chamber also includes an air inlet. A one-way check valve is provided in fluid communication with the air inlet for preventing liquid from passing through the air inlet of the mixing chamber. In addition, in some embodiments an air pump is also provide with the refill unit.

Another exemplary refill unit for a dispensing system includes a liquid reservoir and a rotary liquid pump having a liquid inlet in fluid communication with the liquid reservoir. The rotary liquid pump includes a housing, wherein at least a portion of the housing is resilient. The rotary liquid pump also includes a rotor that has one or more apexes wherein during operation, the one or more apexes contact the resilient portion of the housing and deflect the resilient portion of the housing resulting in the movement of a liquid. A mixing chamber having a liquid inlet and an air inlet is also provided. The liquid pump outlet is in fluid communication with the mixing chamber liquid inlet and the air inlet if in fluid communication with an air pump. An outlet nozzle is in fluid communication with the mixing chamber outlet for dispensing foam formed by mixing the liquid and air together.

### BRIEF DESCRIPTION OF THE DRAWINGS

These and other features and advantages of the present invention will become better understood with regard to the following description, and accompanying drawings where:

FIG. 1 illustrates a prior art rotary pump dispenser system.

FIGS. 2A, 2B and 2C illustrate a prior art rotary pump.

FIG. 3 illustrates a foam dispensing system having a rotary liquid pump and air pump in accordance with an embodiment of the present invention.

FIG. 4 illustrates a rotary pump for pumping liquid and air in accordance with an embodiment of the present invention.

FIG. 5 illustrates a rotary pump for pumping liquid and air in accordance with an embodiment of the present invention.

FIGS. 6A and 6B illustrate an additional embodiment of a rotary liquid pump and air pump in accordance with an embodiment of the present invention.

FIG. 7 illustrates a turbine for an air pump in accordance with an embodiment of the present invention.

FIG. 8 illustrates a rotary liquid pump and pancake air pump in accordance with an embodiment of the present invention.

FIG. 9 illustrates a foam dispensing system having a rotary liquid pump and air pump wherein the foam pump is a split pump and one of the liquid pump or air pump may be replaced without replacing the other in accordance with an embodiment of the present invention.

FIG. 10 illustrates a rotary liquid pump and rotary air pump in accordance with an embodiment of the present invention.

FIG. 11 illustrates a rotary liquid pump and air pump in accordance with an embodiment of the present invention.

FIGS. 12A and 12B illustrate a diaphragm air pump in accordance with an embodiment of the present invention.

FIG. 13 illustrates a rotary liquid pump and piston air pump in accordance with an embodiment of the present invention; and

FIG. 13A illustrates a cam and cam follower for use in the embodiment of FIG. 13.

### DETAILED DESCRIPTION

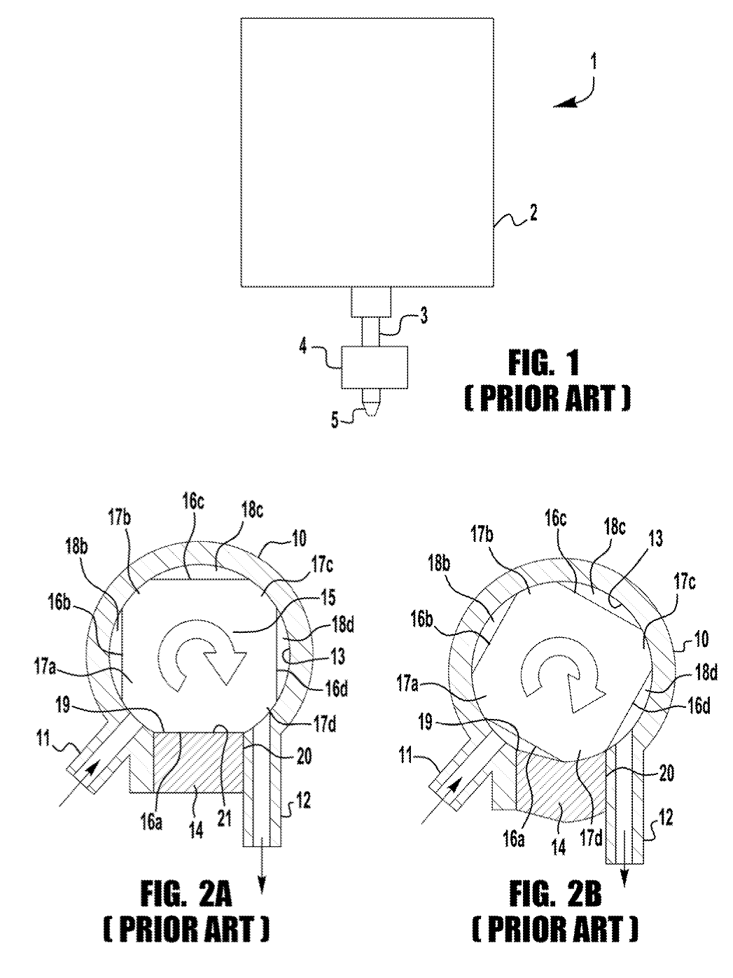

FIG. 1 illustrates a prior art liquid dispenser 1. The liquid dispenser 1 includes a liquid reservoir 2, a feed tube 3, a rotary pump 4 and a dispensing nozzle 5. Liquid is pumped from liquid reservoir 2 through feed tube 3 by rotary pump 4 and dispensed through outlet nozzle 5. Rotary pump 4 may be a rotary pump such as, for example, the pump disclosed in U.S. Pat. No. 7,674,100, which is titled Pump With Conveying Chamber Formed in Outer Rotor Surface, and is incorporated herein by reference in its entirety.

FIGS. 2A-2C illustrate a prior art rotary pump 4 that has a housing 10 which may be formed of a molded plastic such as, for example, polyethylene or polypropylene. Housing 10 has an inlet 11 and an outlet 12. The interior of housing 10 is substantially cylindrical and the portion of the interior of housing 10 between outlet 12 and inlet 11, in clockwise direction, includes a seal 14 that is described in more detail below.

Housing 10 also contains a rotor 15 that may be formed of stainless steel or may be an injection molded plastic part. Rotor 15 has a generally circular cross-section and includes four recessed surfaces 16a, 16b, 16c and 16d that are interconnected by apices 17a, 17b, 17c and 17d formed by unrelieved portions of the rotor 15. Each apex is rounded with a curvature that matches the curvature of the cylindrical housing surface 13 so that the rotor 15 has an interference fit within the cylindrical housing surface 13. As a result, each recessed surface 16a, 16b, 16c and 16d forms a respective chamber 18a, 18b, 18c and 18d between the cylindrical housing surface 13 and respective surfaces 16a, 16b, 16c, 16d as the rotor travels around housing surface 13. If housing 10 is formed from a resilient plastic material that deforms under load, rotor 15 may be arranged to distend the housing 10 slightly to ensure a fluid-tight seal around each surface 16a, 16b, 16c, 16d.

Seal 14 is formed by a block of elastomeric material that is compliant, flexible and/or resilient. Seal 14 is connected to housing 10 to prevent fluid from passing between seal 14 and housing 10. Seal 14 has a first axial edge 19 adjacent inlet 11 and a second axial edge 20 adjacent outlet 12. Seal 14 has a rotor engaging surface 21 that has a length between the first and second edges 19, 20 that is generally equal to the length of each of the recessed surfaces 16a, 16b, 16c and 16d between the associated apices 17a, 17b, 17c, 17d and is shaped to match the shape of each recessed surface 16a, 16b, 16c, 16d. The axial extent of seal 14 is at least the same as the axial extent of recessed surfaces 16a, 16b, 16c, 16d. The seal 14 projects into the space defined by an imaginary cylinder described by a continuation of the cylindrical housing surface 13 between inlet 11 and outlet 12. Seal 14 may be flexed between the first and second axial edges 19, 20 so that it bows outwardly relative to seal 14 towards the axis of rotor 15 if the recessed surfaces 16a, 16b, 16c, 16d are concave. The natural resilience of the material will tend to return seal 14 to the undistorted disposition after distortion by rotor 15, and this may be assisted by a spring (not shown) acting on the radially outer end of seal 14.

During operation, inlet 11 is connected to a source of fluid to be pumped and outlet 12 is connected to a destination for the pumped fluid. Rotor 15 is rotated in a clockwise direction. In the position shown in FIG. 2A, the rotor surface 16a engages resilient seal surface 21. In this way, the space between housing 10 and rotor 15 is closed in this zone and the passage of fluid from outlet 12 to inlet 11 is prevented. In this position, apex 17a is aligned with inlet 11 while rotor surfaces 16b, 16c, 16d form respective sealed chambers 18b, 18c, 18d with cylindrical housing surface 13.

On rotation of rotor 15 by about 30° (FIG. 2B), chamber 18d is now connected to outlet 12. The associated apex 17d contacts seal surface 21 and seals against that surface. Accordingly, rotating rotor 15 forces fluid from chamber 18d out of outlet 12. In addition, apex 17a previously aligned with inlet 11 moves away from inlet 11 and allows rotor surface 16a to separate from sealed surface 21 to begin to form a chamber 18a (see FIG. 2C) with cylindrical housing surface 13 and with apex 17d against seal surface 21 causing fluid to be sucked into chamber 18a. Further rotation of rotor 15 by about 60° from the position shown in FIG. 2A results in rotor surface 16d, that previously formed chamber 18d adjacent with outlet 12, begins to contact seal surface 21 and seals against that surface 21. Thus, chamber 18d reduces in volume until it no longer exists and fluid from that chamber is forced through outlet 12. At the same time, rotor surface 16a formerly in contact with seal surface 21 is now clear of that surface 21 and forms a chamber 18a with cylindrical housing surface 13 and chamber 18a receives fluid from inlet 11. Apex 17d between the surfaces 16a and 16d moves out of engagement with seal surface 21 and starts to align with the inlet 11. Rotor 15 moves to a position equivalent to the position shown in FIG. 2A and pumping continues. Accordingly, fluid is pumped between inlet 11 and outlet 12.

The rate of flow of liquid is proportional to the rate of rotation of rotor 15 and the volumes of chambers 18a, 18b, 18c and 18d. Although rotor 15 is shown as having four surfaces 16a, 16b, 16c, 16d, it could have any number of surfaces such as one or two or three surfaces or more than four surfaces. Surfaces 16a, 16b, 16c, 16d may be planar, or may be, for example, convexly or concavely curved. Preferably, they are shaped as indentations formed by the intersection with the rotor 15 of an imaginary cylinder having its axis at 90° to the axis of the rotor and offset to one side of the rotor axis. As described above, rotor engaging surface 21 of seal 14 may be shaped to compliment the shape of the surfaces 16a, 16b, 16c, 16d.

Seal 14 acts to prevent the formation of a chamber between outlet 12 and inlet 11 in the direction of rotor 15. The resilience of seal 14 allows it to always fill the space between inlet 11 and outlet 12 and the portion of the rotor 15 in this region. As the pressure differential between inlet 11 and outlet 12 increases, there is an increased tendency for fluid to pass between seal 14 and rotor 15. The use of a spring acting on seal 14, as described above, will decrease that tendency and so allow the pump to operate at higher pressures. Thus, the force applied by the spring determines the maximum pump pressure.

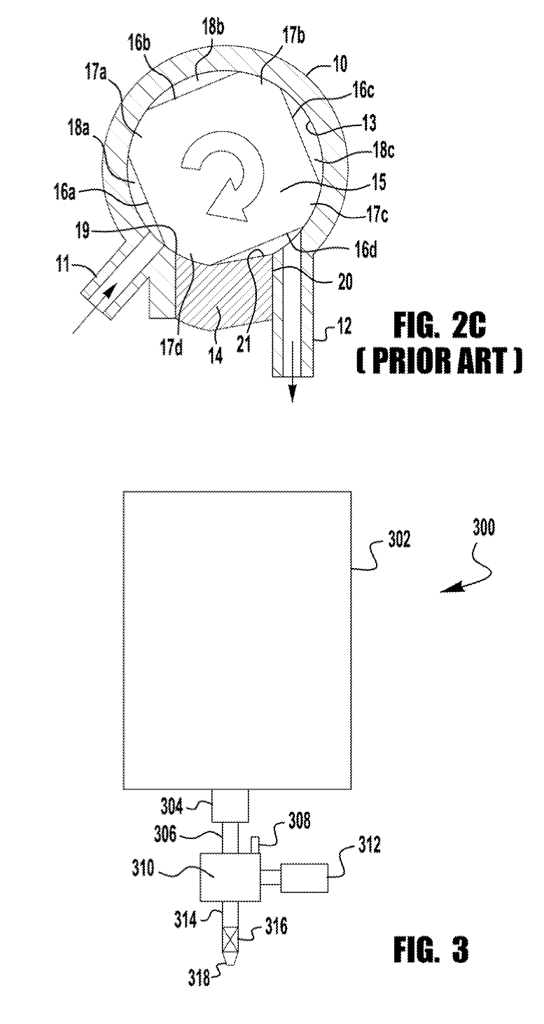

FIG. 3 illustrates a foam dispensing system 300 in accordance with one embodiment of the present invention. Dispensing system 300 includes a housing 301 having an actuator (not shown). The actuator may be a manual actuator or an electronic actuator. In addition, a sensor (not shown) may be included to detect when an object is placed under the outlet nozzle 318 to cause dispensing system 300 to dispense foam. In addition, dispensing system 300 includes a liquid reservoir 302, a connector 304, a fluid inlet tube 306, an air inlet 308, a foam pump 310, a premixing chamber 314, a foam generator 316 and an outlet nozzle 318. Foam pump 310 includes both a liquid pump portion and an air pump portion. Embodiments of suitable pumps are described in detail below. In one embodiment, foam pump 310 is driven by an electric motor 312. Electric motor 312 may be an AC motor or a DC motor and may be powered by a standard electrical source, such as 115 VAC outlet or by batteries.

During operation, foam pump 310 is driven by motor 312 and liquid is drawn into the liquid pump portion of foam pump 310 from liquid reservoir 302 via liquid inlet 306. Simultaneously, air is drawn in from air inlet 308 and pressurized by the air pump portion in foam pump 310. The pumped liquid and pressurized air are combined in premix chamber 314 to form a mixture that is forced through foam generator 316 to form a rich foam. The foam is dispensed through nozzle 318.

The dispensing system 300 may be used in foam dispensers that are mounted on walls, stands or cabinets. In some embodiments, dispenser system 300 may be used in an under-countertop configuration wherein the outlet nozzle 318 is located above the countertop and the liquid reservoir 302, air pump portion and liquid pump portion may be located below the countertop.

FIG. 4 illustrates a rotary pump 400 having a liquid pump portion and an air pump portion in accordance with one embodiment of the present invention. The internal functioning of pump 400 is similar to the functions described above with respect to FIGS. 2A-2C. However, pump 400 includes both a liquid pump portion and an air pump portion. Pump 400 includes a shaft 402 that rotates within a housing 404 in the direction of arrow 430. Housing 404 has a substantially circular cross section along the pump shaft and includes one or more resilient sealing members (not shown) located between the inlets and the outlets similar to seal 14 described above with respect to FIGS. 2A-2C. Preferably, there is a first resilient sealing member (not shown) located between liquid inlet 410 and liquid outlet 412, and a second resilient sealing member (not shown) located between air inlet 414 and air outlet 416. In this embodiment, shaft 402 has a first recess 406 (or plurality of recesses 406) that has a first size. First recesses 406 are used to form cavities for pumping a liquid. Recesses 406 are similar to recesses 16a, 16b, 16c and 16d described above with respect to FIGS. 2A-2C. In addition, shaft 402 also includes second recess 408 (or plurality of recesses 408). Second recesses 408 are larger than first recesses 406 so that a greater volume of air is pumped through the air outlet 416 than the volume of liquid that is pumped through the liquid outlet 412. Second recesses 408 are also similar to recesses 16a, 16b, 16c and 16d described above with respect to FIGS. 2A-2C. Air from the air outlet 416 and liquid from the liquid outlet 412 mix together in mixing chamber 418 and pass through a foam generator 420. In one embodiment, foam generator includes screens 421 to generate a high quality foam. The foam is dispensed through outlet nozzle 422.

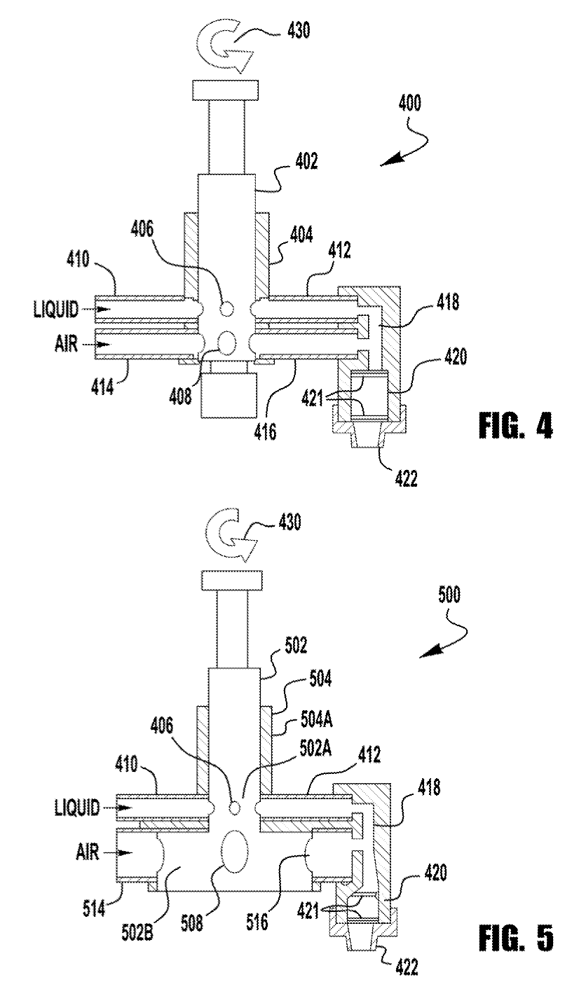

FIG. 5 illustrates another rotary pump 500 having a liquid pump portion and an air pump portion in accordance with one embodiment of the present invention. Pump 500 is similar to pump 400; however, shaft 502 includes a first portion 502A that has a first diameter and includes a plurality of first recesses 406, and a second portion 502B that has a second diameter and includes a plurality of second recesses 508. Similarly, housing 504 includes a first portion that is substantially circular and has a first diameter, and a second portion that is substantially circular and has a second diameter. Pump 500 includes a liquid inlet 410 and a liquid outlet 412, and air inlet 514 and an air outlet 516. In addition, the housing 504 has a first resilient member (not shown) located between the liquid inlet 410 and the liquid outlet 412 in the first housing portion 504A, and a second resilient member (not shown) located between the air inlet 514 and the air outlet 516. The second diameter of the second shaft portion 502B is larger than the first diameter of the first shaft portion 502A, and the second recesses 508 are larger than the first recesses 406. Thus, the volume of air that is pumped with each rotation of shaft 502 is greater than the volume of liquid. The ratio of air to liquid may be adjusted by adjusting the differences in diameters of the shaft and by adjusting the depth of the recesses 508 in the shaft. As described above, during operation, air from the air outlet 516 and liquid from the liquid outlet 412 mix together in mixing chamber 418 and pass through a foam generator 420. In one embodiment, foam generator includes screens 421 to generate a high quality foam. The foam is dispensed through outlet nozzle 422.

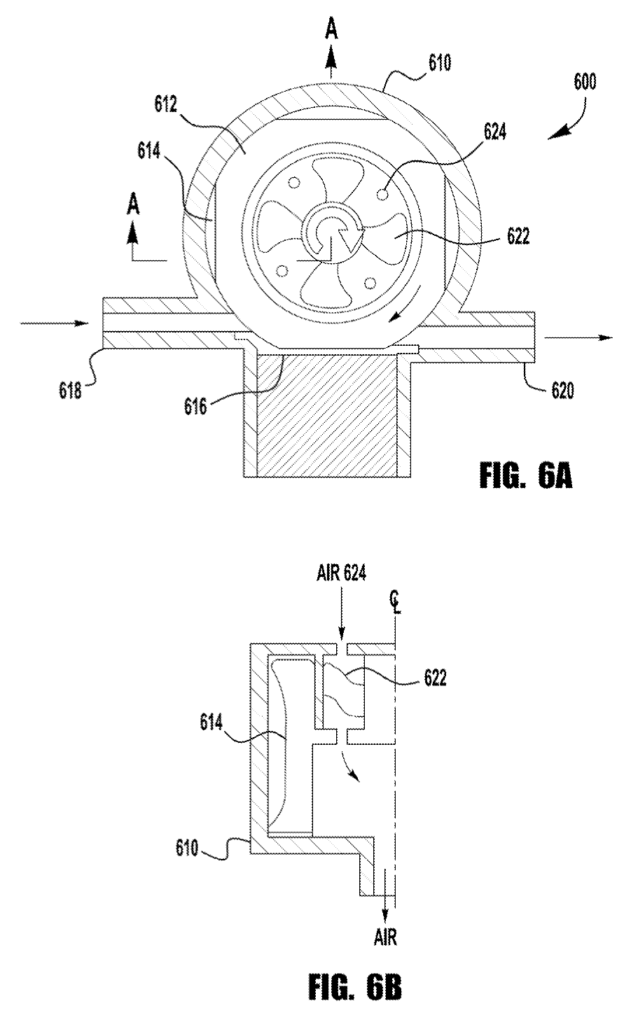

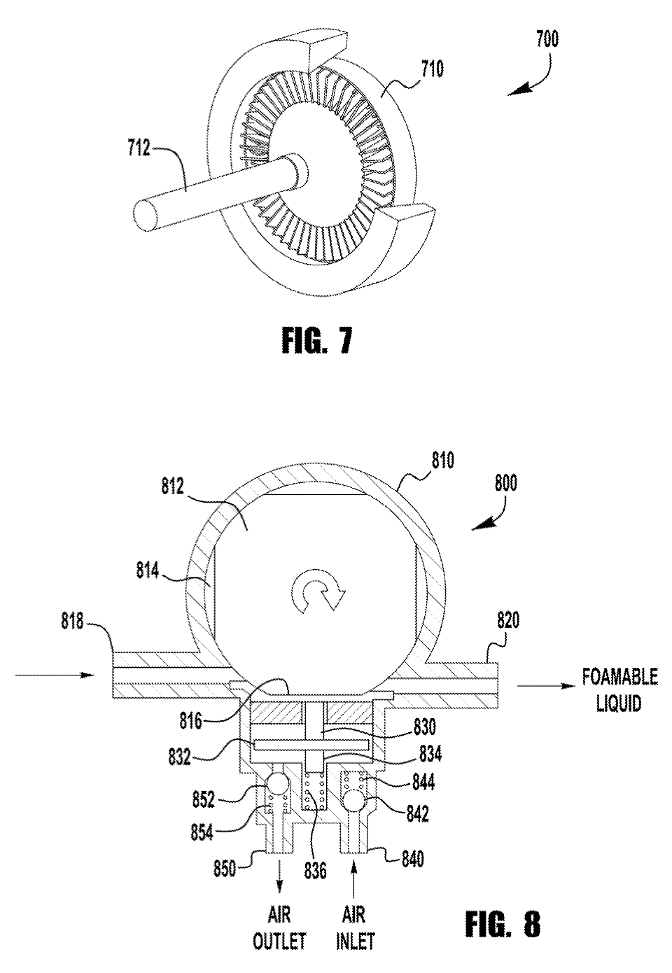

FIGS. 6A and 6B illustrate yet another embodiment of a pump 600 that has a liquid portion and an air pump portion. FIG. 6B is a cross-sectional view of FIG. 6A taken at arrows A. Pump 600 includes a liquid pump portion that includes a housing 610, a rotor 612, recesses 614 in rotor 612, a resilient sealing member 616, a liquid inlet 618 and a liquid outlet 620 which are similar to those described in detail above. In addition, FIGS. 6A and 6B illustrate an air pump portion that includes a fan 622 connected to rotor 612 and rotates with rotor 612, and air inlet holes 624 to allow air to flow into the air pump portion. During operation, as the rotor 612 rotates, liquid is pumped through liquid outlet 620. Simultaneously, fan 622 rotates at the same speed as rotor 612 and pumps air through an air outlet (not shown) that connects with the liquid outlet 620 at a premixing chamber (not shown) similar to those described above. In one embodiment, although the fan 622 rotates at the same speed as rotor 612, more air than liquid is pumped through the pump because liquid is pumped only over the recessed portion 614 of the rotor 612, while air is continuously pumped while the rotor 612 is rotating. FIG. 7 illustrates an embodiment of a turbine 700 having fins 710 and a shaft 712. Turbine 700 may be used in place of fan 622 described above.

FIG. 8 illustrates yet another embodiment of a pump 800 having a rotary liquid pump portion and a pancake air pump portion. Liquid pump portion 800 includes a housing 810, a rotor 812, recesses 814 in rotor 812, a resilient sealing member 816, a liquid inlet 818 and a liquid outlet 820 which are similar to those described in detail above. The air pump portion includes an air inlet 840, an air inlet check valve 842 and associated spring 844, an air outlet 850, an air outlet check valve 852 and associated biasing spring 854, a plunger 832 that has a first projecting member 830, a second projecting member 834 and a biasing spring 836. During operation, as rotor 812 rotates and deflects resilient sealing member 816, resilient sealing member 816 contacts first projecting member 830 which forces plunger 832 downward. As plunger 832 is forced downward, check valve 842 seats and prevents air from escaping through the air inlet 840. Check valve 852 moves off of its seat and air is forced out air outlet 850. When the resilient sealing member 816 moves back to the position shown in FIG. 8, biasing spring 836 forces projection 834 and plunger 832 upward causing check valve 852 to seat and drawing air in through the air inlet 840 past check valve 842. As discussed above, the air outlet 850 and liquid outlet 820 may be joined at a premix chamber (not shown) to form a mixture, forced through a foam generator (not shown) and dispensed out through a nozzle (not shown) as a foam. Although pump 800 is illustrated as a single unit, the liquid pump portion and the air pump portion may be formed as two separate parts whereby the liquid pump portion may be disposed of with a refill unit, while the air pump portion remains with a dispenser (not shown).

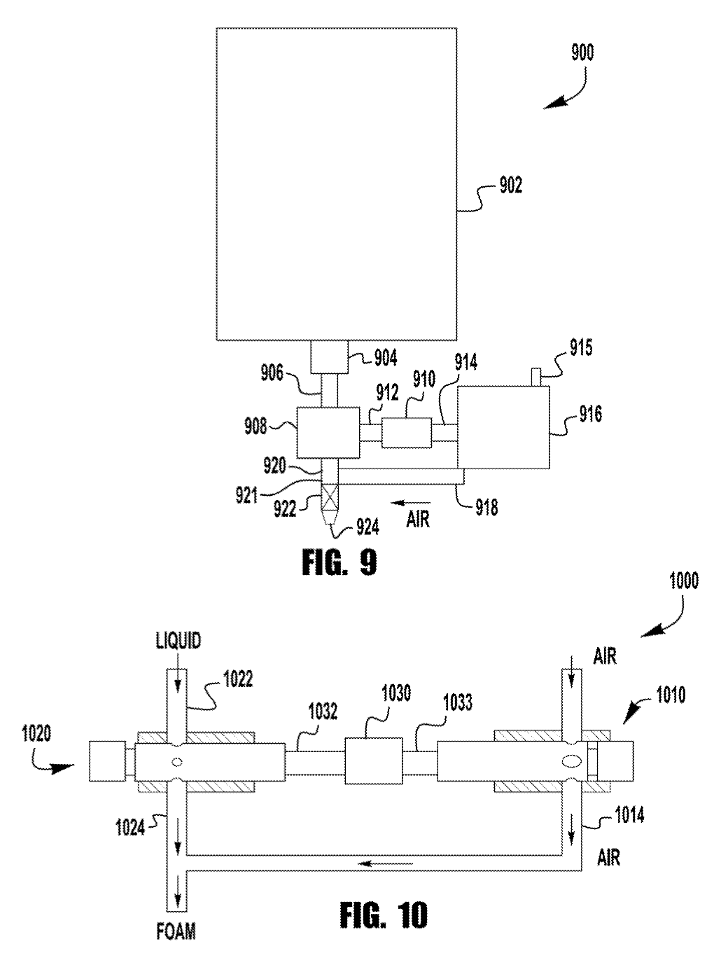

FIG. 9 illustrates a foam dispensing system 900 in accordance with one embodiment of the present invention. Dispensing system 900 includes a liquid reservoir 902, a connector 904, a inlet tube 906, a rotary liquid pump 908, a liquid delivery tube 920, a premix chamber 921, a foam generator 922 and an outlet nozzle 924. These components are in fluid communication with one another and all of them come in contact with liquid from the liquid reservoir 902. In one embodiment, these components are part of a refill unit and may be disposed of upon depletion of the liquid from the liquid reservoir 902. In addition, the foam dispensing system 900 includes an air pump 916, an air inlet 915 and an air delivery tube 918. In one embodiment, the air pump 916 and air delivery tube 918 are secured to the dispensing system and are not disposed of while replacing the refill unit. This concept of having a foam pump that has a liquid pump portion readily separable from an air pump portion may be referred to as a “split pump.”

Air delivery tube 918 connects to the premix chamber 921 allowing air to enter premix chamber 921 and mix with liquid. In one embodiment, air delivery tube 918 includes a check valve (not shown) and a sealing member (not shown) to releasably connect to premix chamber 921. The check valve prevents liquid from entering into the air delivery tube 918. Optionally, the check valve (not shown) may be attached to premix chamber 921 and disposed of with the refill unit while the sealing member is attached to the air delivery tube.

In one embodiment, liquid pump 908 and air pump 916 are driven by an electric motor 910 that includes two shafts, 912 and 914. Shaft 912 drives liquid pump 908 and shaft 914 drives air pump 916. Electric motor 910 may be an AC motor or a DC motor and may be powered by a standard electrical source, such as 115 VAC outlets or by batteries. Shafts 912 and 914 may include gears (not shown) to permit liquid pump 908 and air pump 916 to be rotated at different speeds. Rotating the pumps at different speeds allows the ratio of the flow rate of the air to liquid to be adjusted. In one embodiment, air pump 916 and liquid pump 908 have the same volume capacity and the air pump 916 is rotated at a speed required to have an air flow rate between about five and fifteen times the liquid flow rate and preferably at about ten times the liquid flow rate. In another embodiment, the volume capacity of the air pump 916 is greater than the volume capacity of the liquid pump 908 so that one revolution of the air pump 916 outputs a greater volume of air than the amount of liquid output by one revolution of the liquid pump 908. Again, the air flow rate may be, for example, between about five and fifteen times the liquid flow rate, and more preferably about ten times the liquid flow rate.

In operation, when a shot of foam is requested, liquid pump 908 rotates and draws liquid from liquid reservoir 902 through liquid inlet tube 906 and pumps the liquid out through liquid delivery tube 920. Simultaneously, air pump 916 draws in air and pumps the air through air delivery tube 918. Air delivery tube 918 and liquid delivery tube 920 are fluidly coupled at premixing chamber 921 where the liquid and air mix together to form a mixture. The mixture passes through a foam generator 922 to form a rich foam and the foam is dispensed through outlet nozzle 924.

FIG. 10 illustrates another embodiment of a foam pump 1000 that includes a rotary air pump portion 1010 having an air inlet 1012 and an air outlet 1014 and a rotary liquid pump portion 1020 having an liquid inlet 1022 and a liquid outlet 1024. The air pump portion 1010 and the liquid pump portion 1020 are driven by an electric motor 1030 that has two shafts 1032 and 1033 to drive the liquid pump portion 1020 and the air pump portion 1010 respectively. This embodiment is similar to the embodiment described above with respect to FIG. 9, and may include all of the features identified with respect thereto. This pump may be set up as a split pump or as a single unit.

FIG. 11 illustrates yet another foam dispensing system 1100 in accordance with an embodiment of the present invention. Foam dispensing system 1100 includes a liquid reservoir 1102, a liquid inlet tube 1104, a liquid pump 1106, a liquid delivery tube 1108, a premix chamber 1129, a foam generator 1128, an outlet nozzle 1130 and a one-way air inlet check valve (not shown) (the wet portion), a motor 1120, a drive shaft 1122 for driving the liquid pump 1106, an air pump 1124, air pump 1124 may be, for example, a rotary blower, a fan or a diaphragm air pump, and an air delivery tube 1126 (the dry portion). The foam dispensing system 1100 functions similar to embodiments described in detail above. Similar to many of the embodiments described herein, the wet portion (also known as a refill unit) may be disposed of after the liquid reservoir is depleted without disposing of the dry portion. This pump may be set up as a split pump or as a single unit.

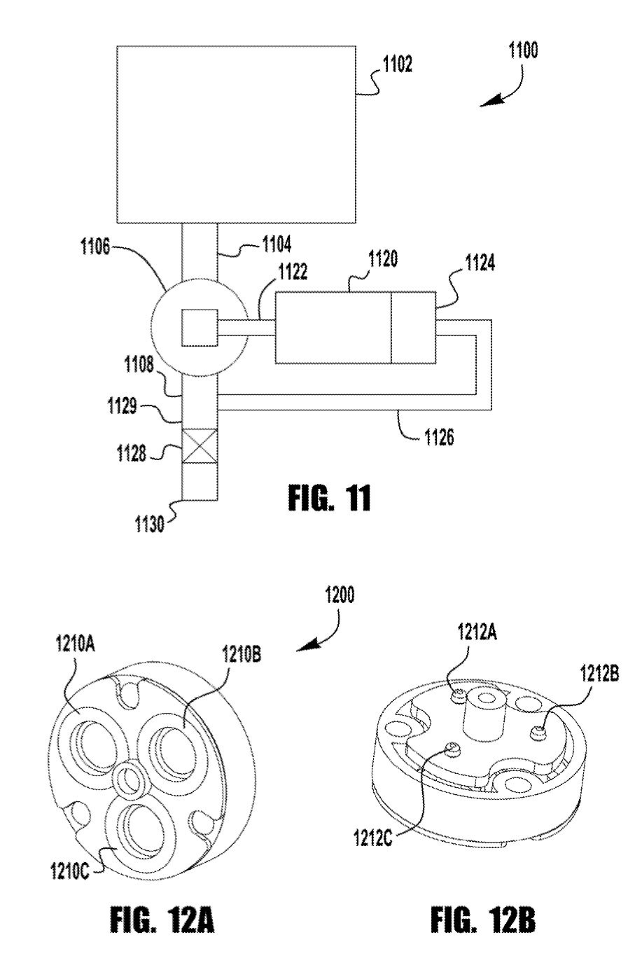

FIGS. 12A and 12B illustrate an embodiment of a diaphragm air pump 1200 that may be used in connection with any of the embodiments described herein, and works particularly well with the embodiment described above with respect to FIG. 10. Air pump 1200 includes three diaphragms 1210A, 1210B and 1210C. On the back side of diaphragms 1210A, 1210B and 1210C are projections 1212A, 1212B and 1212C, respectively. During operation, diaphragm air pump 1200 is connected to the back of a motor by, for example, a cylindrical adaptor (not shown). In one embodiment, the cylindrical adaptor facilitates connecting a projecting member (not shown) to the motor shaft. As the shaft rotates, the projecting member rotates and strikes projections 1212A, 1212B and 1212C causing the diaphragms 1210A, 1210B and 1210C to collapse inward and send a pulse of air out of an outlet (not shown).

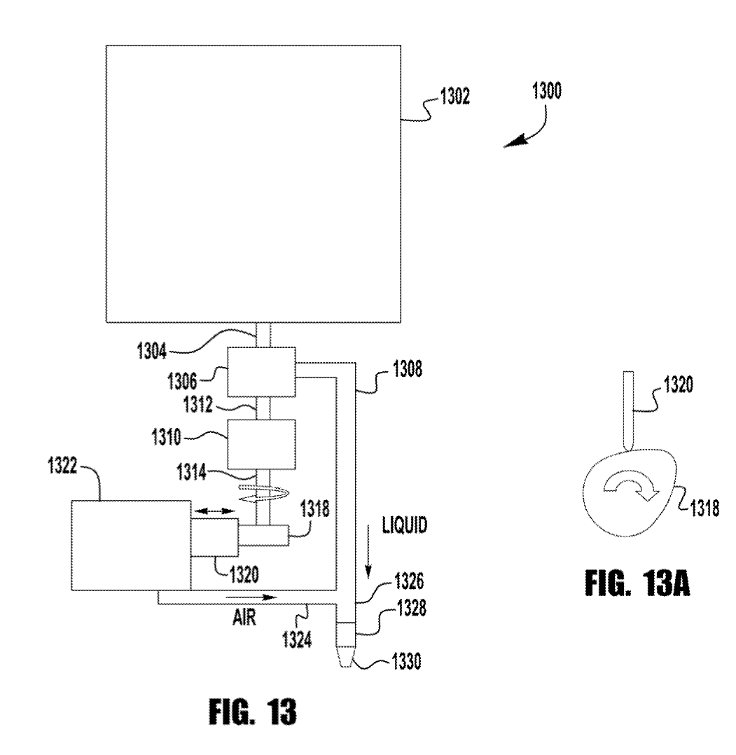

FIG. 13 illustrates yet another foam dispensing system 1300 in accordance with an embodiment of the present invention. Foam dispensing system 1300 includes a liquid reservoir 1302, a liquid inlet tube 1304, a liquid pump 1306, a liquid outlet 1308, a premix chamber 1326, a foam generator 1328 and an outlet nozzle 1330, which form a refill unit and may be disposed of when the liquid reservoir 1302 is depleted. In addition, foam dispensing system 1300 includes a motor 1310 and shaft 1312 for powering pump 1306, and a second shaft 1314 connected to a cam 1318. Cam 1318 is an eccentric cam device that rotates along with the shaft. As cam 1318 rotates, cam follower 1320 moves in and out and drives air piston pump 1322, which causes air to be forced through air delivery tube 1324. Air delivery tube 1324 connects to premix chamber 1326, where it mixes with liquid to form a mixture that is forced through foam generator 1328 and dispensed as a foam at outlet 1330. FIG. 32A illustrates an embodiment of a cam 1318 and cam follower 1320 that may be used in accordance with an embodiment of the present invention. Again, this pump may be set up as a split pump or as a single unit.

The embodiments described herein may all be used in a foam soap dispenser. Such foam dispensers typically have a housing that may be mounted on a wall and have an actuating mechanism. The actuating mechanism may be a manual actuator or an electronic actuator. The electronic actuator may be actuated by a sensor that senses when a user's hand is in the dispensing area. The housing includes a holder for receiving a liquid reservoir. Aspects of the various embodiments described herein may be used alone or in combination with all or portions of other embodiments described herein even though they are not specifically identified as being combinable with one another.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. For example, the embodiments described herein may be modified to dispense a plurality of different fluids for mixing with air to form a foam. Still yet, the embodiments may be modified to pump and dispense a fluid, a particulate and air as a mixture or foam. Therefore, the invention, in its broader aspects, is not limited to the specific details, the representative apparatus and illustrative examples shown and described. Accordingly, departures may be made from such details without departing from the spirit or scope of the applicant's general inventive concept.

I/we claim:

1. A foam dispensing system comprising:
a dispenser housing,
the dispenser housing having an actuator for causing the dispensing of a foam and a holder for receiving a liquid reservoir;
a liquid reservoir;
a rotary liquid pump having
a pump housing wherein a least a portion of the pump housing has a substantially circular cross-section;
a liquid inlet in fluid communication with the liquid reservoir and a liquid outlet
a sealing member located between the liquid inlet and the liquid outlet;
a liquid pump rotor having one or more recesses located therein, wherein during operation, the sealing member is configured to seal against the one or more recesses when the recess is located against the sealing member; and
a liquid outlet in fluid communication with a mixing chamber;
an air pump having an air inlet and an air outlet;
the air outlet in fluid communication with the mixing chamber; and
an outlet nozzle, wherein the mixing chamber is in fluid communication with the outlet nozzle.

2. The foam dispensing system of claim 1 wherein the air pump comprises a rotary air pump having an air pump rotor with one or more recesses located therein and a motor drives the both the liquid pump rotor and the air pump rotor.

3. The foam dispensing system of claim 1 wherein the air pump comprises a fan.

4. The foam dispensing system of claim 1 wherein the air pump comprises a diaphragm air pump.

5. The foam dispensing system of claim 1 wherein the air pump comprises a piston air pump.

6. The foam dispensing system of claim 1 further comprising a one-way check valve located between the air outlet of the air pump and the mixing chamber.

7. A refill unit for a foam dispensing system comprising:
a liquid reservoir connected to a rotary liquid pump;
the liquid rotary pump including
a housing, wherein at least a portion of the housing is resilient and extends along a plane; and
a rotor, wherein at least a portion of the rotor includes a planar portion,
a liquid inlet in fluid communication with the liquid reservoir; and
a liquid outlet in fluid communication with a mixing chamber;
the mixing chamber having an air inlet;
a one-way check valve in fluid communication with the air inlet for preventing liquid from passing through the air inlet of the mixing chamber.

8. The refill unit of claim 7 further comprising an air pump having an air outlet connected to the air inlet of the mixing chamber.

9. The refill unit of claim 8 wherein the air pump comprises a rotary air pump having an air pump rotor with one or more recesses located therein and a motor drives the both the liquid pump rotor and the air pump rotor.

10. The refill unit of claim 8 wherein the air pump comprises a fan.

11. The refill unit of claim 8 wherein the air pump comprises a diaphragm air pump.

12. The refill unit of claim 8 wherein the air pump comprises a piston air pump.

13. A refill unit for a dispensing system comprising:
a liquid reservoir;
a rotary liquid pump having a liquid inlet in fluid communication with the liquid reservoir;
the rotary liquid pump having a housing, wherein at least a portion of the housing is resilient;
the rotary liquid pump having a rotor that has one or more apexes wherein during operation, the one or more apexes contact the resilient portion of the housing and deflect the resilient portion of the housing;
a mixing chamber having a liquid inlet and an air inlet;
the liquid pump outlet in fluid communication with the mixing chamber liquid inlet;
an outlet nozzle in fluid communication with the mixing chamber for dispensing foam.

14. The refill unit of claim 13 further comprising a check valve located in fluid communication with the mixing chamber air inlet to prevent fluid from passing through the mixing chamber air inlet.

15. The refill unit of claim 14 further comprising an air pump connected to the air inlet.

16. The refill unit of claim 15 wherein the air pump comprises a rotary air pump having an air pump rotor with one or more apexes located thereon and a motor drives both the liquid pump rotor and the air pump rotor.

17. The refill unit of claim 15 wherein the air pump comprises a fan.

18. The refill unit of claim 15 wherein the air pump comprises a diaphragm air pump.

19. The refill unit of claim 15 wherein the air pump comprises a piston air pump.

20. The refill unit of claim 15 wherein the outlet nozzle is located above a counter top and the liquid pump and the air pump are located below a counter.
